(19) United States
(12) Patent Application Publication
(10) Pub. No.: US 2022/0007633 A1
(43) Pub. Date: Jan. 13, 2022

(54) Thermal Pest Barrier for Structures

(71) Applicant: Nicholas Joseph Nedwed, Houston, TX (US)

(72) Inventor: Nicholas Joseph Nedwed, Houston, TX (US)

(21) Appl. No.: 17/447,208

(22) Filed: Sep. 9, 2021

Related U.S. Application Data
(60) Provisional application No. 63/050,865, filed on Jul. 12, 2020.

(51) Int. Cl. A01M 29/14; A01M 29/34; E02D 31/00

(52) U.S. Cl. CPC A01M 29/14; E02D 31/00; A01M 29/34

(57) ABSTRACT

The present invention provides a novel method of protecting simple to very complex structures that have a foundation sitting on soil from penetration by crawling insects or other pests. This is accomplished by encircling the structure to be protected with a strip of material that is capable of being heated sufficiently that the temperature of its outer surface is high enough that insects or other pests will not come into contact or pass over it and thereby will not enter the structure. Crawling insects that will be prevented from entering a structure include but are not limited to termites, millipedes, ants, and cockroaches.

### FEDERAL FUNDING LEGEND

This invention was not created using federal funds.

### BACKGROUND OF THE INVENTION

### Field of the Invention

The present invention generally relates to a system that protects structures from intrusion by pests such as termites, millipedes, cockroaches, ants and other insects/pests. The invention protects all types of structures from these pests including homes, commercial office buildings, warehouses, hotels/motels, restaurants, apartment complexes, retirements homes, shopping malls, strip malls, retail centers, grocery stores, etc.

### Description of the Related Art

Subterranean termites cause more damage to wooden structures than any other insect pest in the United States. Approximately 600,000 homes in the United States are damaged each year resulting in an estimated $5,000,000,000 spent each year to either control termites or repair termite damage. They live in large underground colonies and attack any wood in contact with the ground. They even construct protective tubes over non-wood material, such as the concrete foundation of a structure, to attack wood above ground. Termites exist in 49 states with the exception being Alaska but they are most common in Southern States.

Good building practices to keep buildings dry is one way of preventing termite infestations. Pressure-treated lumber can keep termites away but they may travel over treated wood to reach untreated wood. Soil-applied insecticides are the most common method of preventing termites. Control of termites in existing structures requires periodic inspections, remedial insecticide treatment, or use of insecticide bait technology.

Millipedes are occasional pests that sometimes invade buildings in large numbers. They are less destructive than termites; they do not bite, carry disease, destroy wood, or infest food. Nonetheless, a large infestation is unpleasant. Application of pesticides along baseboards and other interior areas of a home do not stop millipede invasions. Once inside, millipedes travel in search of moisture but soon die from lack of it. Removal of millipedes in a home requires constant sweeping or vacuuming.

Approximately 30 species of cockroaches associate with humans and feed on human and pet food. They can carry pathogenic microbes into structures. They also cause allergic reactions in some humans that are linked with asthma. Approximately 20-50% of homes with no visible signs of cockroaches have detectable allergens in dust.

Baking soda has been used to control cockroaches but there is no evidence of effectiveness. Poison baits containing boric acid, hydramethylnon or fipronil have proven effective on adults. Egg-killing baits are also effective at reducing populations. Insecticides containing deltamethrin or pyrethrin have proven effectives. A study by Purdue University found that most cockroaches in the US were able to develop immunity to multiple types of pesticides.

Ants are mostly a nuisance and don't cause significant damage to structures. The exception, however, is carpenter ants. They will tunnel and nest in wood to cause serious structural damage. Although not as damaging as termites, estimates are that carpenter ants cause hundreds of millions of dollars of damage each year in the United States.

A “Quick Search” of the USPTO patents from 1976 to present using the terms “termite” and “control” resulted in the following 52 patents: U.S. Pat. Nos. 10,681,904, 10,375,957, 10,334,835, 9,872,487, 9,848,605, 9,833,001, 9,655,354, 9,149,030, 8,881,448, 8,832,994, 8,753,658, 8,720,108, 8,454,985, 8,263,526, 8,196,342, 7,790,151, 7,272,993, 7,037,494, 6,581,325, 6,568,559, 6,389,741, 6,298,597, 6,290,992, 6,205,701, 6,203,811, 6,071,951, 6,065,241, 6,016,625, 6,003,266, 5,950,356, 5,915,949, 5,901,496, 5,899,018, 5,802,779, 5,756,114, 5,747,519, 5,728,573, 5,678,362, 5,571,967, 5,555,672, 5,329,726, 5,317,831, 5,184,418, 4,858,375, 4,811,531, 4,698,943, 4,625,474, 4,504,468, 4,043,073, 3,940,875, 3,858,346, and 3,835,578. A review of these patents found that none rely on a thermal barrier and most rely on some form of toxic pesticide.

A licensed technology called ThermaPure® or ThermaPureHeat® is used to treat whole structures or parts. Insects, unlike mammals, cannot regulate their body temperatures metabolically and so are unable to withstand extreme temperatures. The ThermaPure® technology exploits this vulnerability using hot air to heat the interior of structures until the wood reaches temperatures exceeding 120° F. for multiple hours. This results in the death of insects that may inhabit these structures. U.S. Pat. No. 4,817,32 describes a method of applying a heated gas to surfaces in a structure to raise the temperature for a period of time sufficient to kill insects.

A need exists for an effective, non-chemical method of controlling pest infestation on structures.

### SUMMARY OF THE INVENTION

In a preferred embodiment, the present invention is directed to the protection of structures from insect infestations using heat. The invention does not attempt to kill insects; rather it is directed at deterring them from entering a structure. This is accomplished by placing a strip of material around the entire perimeter of a structure at on near the foundation and above the soil. The strip of material is kept at a temperature sufficiently above ambient temperature to keep insects from crawling over said material.

In another embodiment, the strip of material is constructed of an insulated wire that is heated to the desired temperature by passing an electric current through the wire. A temperature controller is used that senses the temperature of the wire and adjusts the electric current accordingly to maintain the outer surface of the wire at a temperature sufficient to deter insects from crawling over the wire.

In yet another embodiment, the strip of material is constructed of self-regulating heating cables that automatically adjust their temperature depending on the ambient temperature to maintain a surface temperature sufficient to deter insects from crawling over the cable.

In still yet another embodiments, the strip of material is a metallic tube or conduit that is connected to a hot fluid reservoir in a flow loop. The hot fluid reservoir could be a reservoir of water that is heated via an electric heat source or a gas heat source. A pump is used to circulate the fluid through the metallic tubing that is attached directly to the foundation of a structure above the soil line to completely surround the structure. The fluid is passed into one end of the tubing or conduit via the pump and returns to the hot fluid reservoir for reheating and recirculating. A temperature control system is used to maintain the temperature of the hot fluid in the hot-fluid reservoir.

In another embodiment, the strip of material is non-metallic tubing that is connected to a hot fluid reservoir in a flow loop. The non-metallic tubing is attached directly to the foundation of a structure above the soil line to completely surround the structure. The hot fluid reservoir could be a reservoir of water that is heated via an electric heat source or a natural-gas fired heat source. A pump is used to circulate the fluid through the conduit or tubing. The fluid is passed into one end of the tubing via the pump and returns via the other end to the hot fluid reservoir for reheating and recirculating. A temperature control system is used to maintain the temperature of the hot fluid reservoir.

### BRIEF DESCRIPTION OF THE DRAWINGS

FIG. 1 presents a side view of an illustrative example of a structure with a thermal pest barrier system. In this example, the thermal barrier consists of a metal or non-metal tube or conduit that completely surrounds the structure at the foundation just above the soil line. The tube or conduit is used to circulate a hot fluid (e.g., water) around the structure. The hot fluid heats the tube or conduit to a temperature sufficiently high to keep insects or other pests from contacting and passing over the tube or conduit and thereby from entering the structure. In this example, the fluid is heated with an electric heater inside the hot-fluid reservoir in direct contact with the hot fluid. In this example, a system that may include a thermocouple and a temperature controller is used control the electric heater in a manner that maintains the hot fluid inside the hot-fluid reservoir at the desired temperature. A pump draws the hot fluid from the reservoir, into the metal or non-metal tube encircling the structure that then discharges the hot fluid back into the hot-fluid reservoir.

FIG. 2 presents a second example of a thermal pest barrier system. This example includes most of the same elements as in FIG. 1 with the exception that the hot fluid is heated in a hot-fluid reservoir by a natural-gas flame. A system that may include a thermocouple and a temperature controller is used to control the natural-gas flame in a manner that maintains the hot fluid inside the hot-fluid reservoir at the desired temperature in a similar to that shown in FIG. 1 and keeps insects or other pests from contacting and passing over it.

FIG. 3 presents a third example of a thermal pest barrier system. In this example, the thermal barrier that completely encircles the structure at or near the foundation above the soil is constructed from self-regulating heat cable. This cable is electrically powered and made with an electrically conductive core that adjusts its conductivity based on changes in the ambient temperature. Two buss wires carry electricity to the conductive core. The cable also includes a metallic over shield along its entire length that acts as a ground. By connecting the heat cable to a supply of electricity allows it to automatically adjust the amount of current and resistance heating that occurs based on the ambient temperature. Proper construction of the system allows it to maintain a temperature sufficient high to keep insects or other pests from contacting and passing over it.

FIG. 4 presents a fourth example of a thermal pest barrier system. In this example, the barrier consists of resistance wire that completely encircles the structure at or near the foundation above the soil in a manner similar to the prior three examples. The resistance wire is connected to a supply of electricity and the current from the supply of electricity is controlled by a system that may include a thermocouple and a temperature controller that maintains the resistance wire at a temperature sufficiently high to keep insects or other pests from contacting and passing over it.

FIG. 5 shows a flow chart of one embodiment of a method of utilizing the thermal pest barrier system to protect a structure from insect or pest penetration.

### DETAILED DESCRIPTION OF THE INVENTION

The present invention provides a thermal pest barrier that completely encircles a structure at or near it's foundation above the soil. The barrier is maintained at a temperature sufficiently above ambient to keep insects and other pests from contacting and passing over it thereby keeping the pests from entering the structure. In a preferred embodiment, the thermal barrier is made from a metallic or non-metallic tube or conduit that completely encircles the structure and provides a conduit for the transfer of a hot fluid, e.g., water. The hot fluid transfers enough heat to the metal or non-metallic tube or conduit to raise the temperature of the outer wall of the tube or conduit high enough to keep insects or other pests from contacting and passing over it. In this preferred embodiment, the hot fluid is heated in a hot fluid reservoir that holds an adequate volume of hot fluid. The hot-fluid reservoir includes an electric heating element that raises the temperature of the hot fluid to the desired temperature. A system that could include a thermocouple in direct contact with the hot fluid in the hot-fluid reservoir and a temperature controller that takes the signal from the thermocouple, determines if the hot fluid is at the desired temperature, and, if not, sends electricity or the appropriate amount of electricity to the electric heating element. A pump withdraws the hot fluid from the hot-fluid reservoir and sends it through the metallic or non-metallic tube or conduit, around the entire structure, and returning back to the hot-fluid reservoir. That is, the hot-fluid is continuously recirculated from and back to the hot-fluid reservoir and continuously reheated.

In another embodiment, a metallic or non-metallic tube or conduit encircles an entire structure at or near the foundation above the soil. This embodiment also includes a hot fluid reservoir and a recirculating pump. In this embodiment, the hot fluid in the hot-fluid reservoir is heated using a natural gas or other combustible gas flame. A system that could include a thermocouple in contact with the hot fluid in the hot-fluid reservoir and a temperature controller that takes the signal from the thermocouple, determines if the hot fluid is at the desired temperature, and, if not, sends natural gas or other combustible gas to a nozzle. Once the gas reaches the nozzle a continuously lit pilot flame or other source of ignition ignites the natural gas or other combustible gas to heat or reheat the hot fluid in the hot-fluid reservoir. A pump withdraws the fluid in the hot-fluid reservoir and sends the hot fluid through the metallic or non-metallic tube or conduit, around the entire structure, and returning back to the hot-fluid reservoir. That is, the hot fluid is continuously recirculated from and back to the hot-fluid reservoir and continuously reheated.

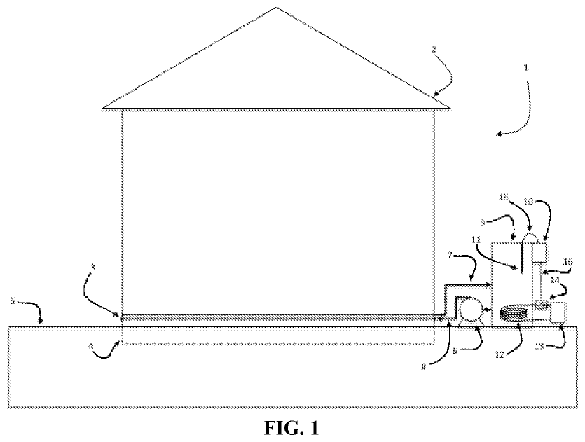

FIGS. 1-4 provide illustrative, non-exclusive examples of methods and systems of the thermal pest barrier that protects structures from insect and other pest penetrations.

In FIGS. 1-4 like numerals denote features and/or structures that work together, and each of the illustrated features and/or structures may or may not be discussed in detail.

Similarly, each feature and/or structure may or may not be numerically labeled in FIGS. 1-4. Any feature and/or structure that are discussed with reference to FIGS. 1-4 may be utilized with any other of FIGS. 1-4 without departing from the scope of the present disclosure.

A given embodiment of the present disclosure is not required to include all features and/or structures that are illustrated in FIGS. 1-4. Any suitable number of such features and/or structures may be omitted from a given embodiment without departing from the scope of the present disclosure.

FIG. 1 presents a conceptual view of an illustrative example 1 of a thermal pest barrier 3 protecting a simple structure 2. Note that in this example, structure 2 appears as a simple structure but the concept is applicable to any structure that is in contact with soil 5 regardless of its size or complexity. In FIG. 1, the barrier 3 is a tube or conduit constructed from a metal (e.g., copper, aluminum, or steel) or a non-metal that is directly attached to and completely encircles the structure 2 at the foundation 4 above the soil 5. The barrier 3 is connected via a metal or non-metallic tube or conduit 8 to a pump 6. The pump 6 is connected to the hot-fluid reservoir 9. The pump 6 withdraws hot fluid from the hot-fluid reservoir 9 and pumps it through the barrier 3 conduit or tube that completely encircles the structure 2. At the other end of the barrier 3 conduit or tube the hot fluid is transferred back to the hot-fluid reservoir 9 via a connecting metal or non-metallic tube or conduit 7. The hot fluid in the hot-fluid reservoir 9 is maintained at a desire temperature (e.g., between 100°-110° F., 110°-120° F., 120°-130° F., 130°-140° F., 140°-150° F., 150°-160° F., 160°-170° F., 170°-180° F., 180°-190° F., or 190°-200° F., or higher) using a temperature controller 10 that receives a voltage signal from a thermocouple 11 via electric wire 15. The thermocouple 11 is in direct contact with the hot fluid in the hot-fluid reservoir 9.

Thermocouple 11 produces a voltage signal that changes in a known way depending on its temperature. Temperature controller 10 receives the voltage signal from thermocouple 11 and converts it into a temperature. The temperature controller than compares the temperature to a preset set-point temperature. If the temperature is below the set-point temperature, the temperature controller sends a current signal through wire 16 to a relay 14 that closes an electric circuit connecting a source of electricity 13 to an electric heater 12 that is in direct contact with the hot fluid located in the hot-fluid reservoir 9. The relay remains closed until the temperature controller determines that the temperature of the thermocouple 11 in direct contact with the hot fluid in the hot-fluid reservoir 9 is above the set-point temperature. When this occurs, the temperature controller stops sending the current signal to relay 14 disconnecting the electric heater 12 from the source of electricity 13 thereby ending heat transfer to the hot fluid until thermocouple 11 produces a current consistent with a temperature below the preset set-point temperature.

FIG. 2 presents a conceptual view of a second illustrative example 1 of a thermal pest barrier 3 protecting a simple structure 2. As in FIG. 1, structure 2 can be any simple or complex structure having a foundation 4 in contact with soil 5. This example differs from the example shown in FIG. 1 in that it uses a heat source 25 that is generated from a flame fed by a combustible gas. The combustible gas can be natural gas, methane, ethane, propane, butane, combinations thereof, or another combustible gas. The barrier 3, pump 6, and lines connecting the pump to the barrier 7, 8 are the same or similar to those described for FIG. 1. A temperature controller 10 in communication with a thermocouple 11 connected by electric wire 15 is used to maintain the temperature of the hot fluid in the hot-fluid reservoir 21. The electric heater 12 shown in FIG. 1 is replaced by heat source that consists of a flame 25 produced by combusting a gas (e.g., natural gas or propane). The flame 25 is connected via a line 26 to a source of combustible gas 23. The temperature controller 10 controls the flame by adjusting valve 24 depending on the temperature controller 10 set point and the temperature of the hot fluid in the hot-fluid reservoir 21 as sensed by thermocouple 11. Valve 24 can be adjusted in increments to increase or decrease the amount of combustible gas reaching the flame 25 or it can be completely closed to shut off flow of combustible gas to flame 25. Complete shut off of the valve 24 could occur when the temperature of the hot fluid in the hot-fluid reservoir is above the set point preset into temperature controller 10. The valve is re-opened to allow flow of combustion gas to the orifice at the end of line 26 if the temperature of the hot fluid in the hot-fluid reservoir drops below the set point. When this occurs, pilot flame 27, which is continuous, re-ignites flame 25 to re-initiate heating of the hot fluid.

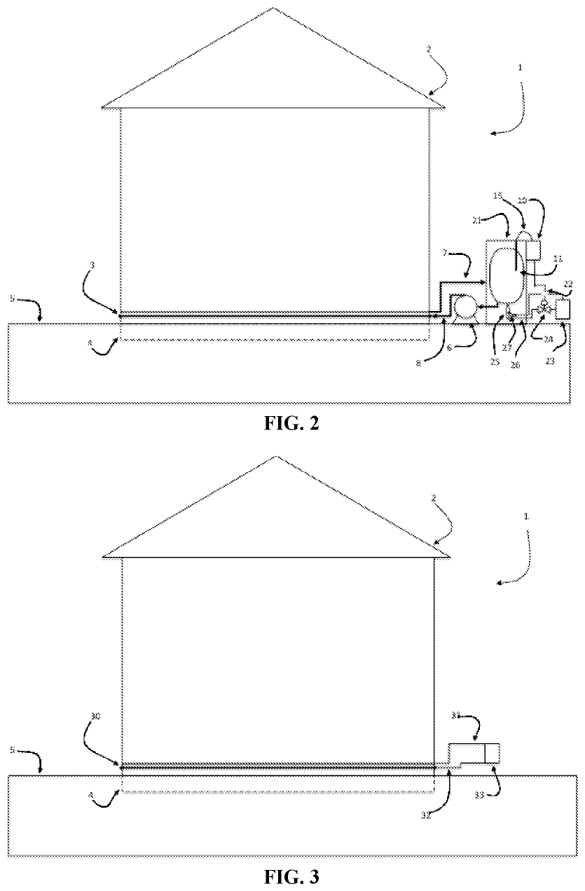

FIG. 3 presents a conceptual view of a third illustrative example 1 of a thermal pest barrier 30 protecting a simple structure 2. This example differs from those shown in FIG. 1 and FIG. 2 in that the barrier 3 is made from a self-regulating heat cable 30 rather than a metallic or non-metallic conduit or tube. The self-regulating heat cable 30 completely encircles structure 1 at or near the foundation 4 above the soil 5. Self-regulating heat cable is electrically powered via electric power source 33 and electric connections 31 and 32. Self-regulating heat cable is made with an electrically conductive core that adjusts its conductivity based on changes in the ambient temperature. Two buss wires carry electricity to the conductive core. The cable also includes a metallic over shield along its entire length that acts as a ground. Connecting the heat cable to a supply of electricity allows it to automatically adjust the amount of current and resistance heating that occurs based on the ambient temperature. Proper construction of the system allows it to maintain a temperature sufficiently high to keep insects or other pests from contacting and passing over it.

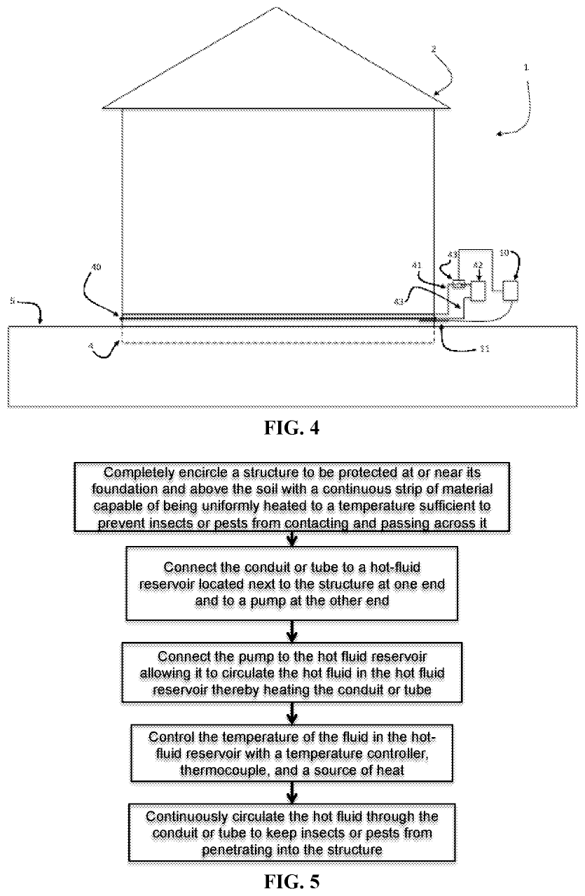

FIG. 4 presents a conceptual view of a fourth illustrative example 1 of a thermal pest barrier 40 protecting a simple structure 2. In this example, the barrier 40 consists of resistance wire that completely encircles the structure at or near the foundation 4 above the soil 5 in a manner similar to the prior three examples. The resistance wire 40 is connected to a supply of electricity 42 via electric wires 41 and 43 and the current from the supply of electricity is controlled by a system that includes a thermocouple 11 and a temperature controller 10 that maintains the resistance wire at a temperature sufficiently high to keep insects or other pests from contacting and passing over it. Temperature controller 10 is connected to a relay 43. Thermocouple 11 is in direct contact with resistance wire 40 allowing it to sense the temperature on it outer surface. When temperature controller 10 receives a voltage from thermocouple 11 that is consistent with resistance wire 40 having a temperature on its outer surface below a preset set-point temperature, temperature controller 10 sends an electric current to relay 43 causing it to close. When relay 43 closes, current from electric supply 42 passes through resistance wire 40 causing it to heat. Heating of resistance wire 40 continues in this way until temperature controlled 10 receives a voltage signal from thermocouple 11 consistent with a temperature on the outer surface of resistance wire 40 being above a preset set-point temperature.

FIG. 5 is a flow chart that shows how the thermal pest barrier system operates. The first step of the operation is to completely encircle a structure to be protected with a conduit or tube, in this example (although other examples are possible). The conduit or tube is placed at or near the foundation above the soil. Next, connect one end of the conduit or tube to a hot-fluid reservoir located next to or near the structure to be protected. Connect the other end of the conduit or tube to a pump. Connect the inlet to the pump to the same hot-fluid reservoir. Turn the pump on to circulate hot fluid from the hot-fluid through the conduit or tube to heat the outer surface of the conduit or tube to a temperature sufficient to keep insects or pest from contacting and passing over it. Control the temperature in the hot-fluid reservoir with a temperature controller, thermocouple, and a source of heat. Continuously circulate the hot fluid from the hot-fluid reservoir through the conduit for as long as desired to keep insects and pests from penetrating the structure that is being protected.

What is claimed is:

1. A system of protecting a structure with a foundation sitting on soil from invasion by insects or other pests comprising
a continuous strip of material that completely encircles the structure and attaches at or near the foundation above the soil, wherein the strip of material is capable of being continuously heated to a temperature sufficient to prevent insects or other pests from contacting the strip and passing over it and into the structure;

2. The system of claim 1, wherein the strip of material is attached in a way that eliminates gaps or openings between the structure and the strip of material using, e.g., clamps screwed into the structure; a glue capable of withstanding the temperature of the strip of material; a sealant capable of withstanding the temperature of the strip of material; a caulk capable of withstanding the temperature of the strip of material; or some other suitable method of attachment;

3. The system of claim 1, wherein the strip of material is a small diameter (e.g., < 1/16″, between 1/16″ and ⅛″, ⅛″ and ¾″, ¼″ and ½″, or ½″ and 1″, or >1″) conduit or tube made from a non-metal or a metal such as copper, aluminum or steel that is filled with a hot fluid that is circulated through the tube or conduit by a pump that is connected to a hot-fluid reservoir; one end of the tube or conduit is connected to the outlet of the pump and the other end connects into the hot fluid reservoir in a manner that allows the hot fluid to be pumped from the hot-fluid reservoir, through the conduit or tube, and then back into the hot-fluid reservoir for reheating and reuse;

4. The system of claim 3, wherein a set of valves allows the flow of hot fluid in the tube or conduit to be reversed using an automatic switch that changes the flow at set intervals in order to keep more uniform temperature along the entire length of the tube or conduit;

5. The system of claim 2, wherein the hot fluid in the reservoir is water or some other fluid capable or being circulated by a pump and heated to a temperature capable of preventing insects or other pests from contacting and passing over a tube or conduit being heated by circulation of the hot fluid;

6. The system of claim 2, wherein the hot fluid in the hot-fluid reservoir is heated by an electric heating element that is in direct contact with the hot fluid in the hot-fluid reservoir;

7. The system of claim 4, wherein the temperature of the hot fluid in the hot-fluid reservoir is maintained by a temperature-control system that consists of a thermocouple in direct contact with the hot fluid in the hot-fluid reservoir that sends an electric voltage to a central processor that converts the voltage to a temperature and then compares the temperature to a temperature pre-set into the central processor by an operator; if the thermocouple voltage is consistent with a temperature below the set-point temperature of the hot fluid in the hot-fluid reservoir then the central processor sends an electric current to an electric relay that allows current from an electric power supply to be sent to the electric heating element to heat the element and thereby heat/reheat the hot fluid in the hot-fluid reservoir; alternatively, if the voltage produced by the thermocouple and sent to the central processor is consistent with a temperature of the hot fluid that is above the hot-fluid temperature set point the central processor does not send a current to the electric relay and thereby does not allow current to flow to and heat the electric heating element; the temperature control system continuously maintains the temperature of the hot fluid in the hot-fluid reservoir at or near the set-point temperature in this way;

8. The system of claim 4, wherein the temperature of the hot fluid in the hot-fluid reservoir is maintained by a temperature-control system that consists of a thermocouple in direct contact with the hot fluid that sends an electric voltage to a central processor that converts the voltage to a temperature and then compares the temperature to a temperature pre-set into the central processor by an operator; if the thermocouple voltage is consistent with a temperature below the set-point temperature of the hot fluid then the central processor sends an electric signal to a control valve to cause it to open or partly open and send a combustible gas (e.g., natural gas, methane, ethane, propane, butane, combinations thereof, or other combustible gas) to a flame in direct contact with the outside of the vessel that holds the hot fluid in the hot-fluid reservoir and thereby heats/reheats the hot fluid; alternatively if the temperature of the hot fluid as monitored by the voltage from a thermocouple sent to the central processor is above the hot-fluid temperature set point the central processor sends an electric signal to the control valve that keeps the valve closed and does not allow the flame to heat the hot fluid; the flame is ignited/re-ignited using a continuous pilot flame or other source of sufficient heat to ignite the combustible gas;

9. The system of claim 1, wherein the strip of material is made from a self-regulating heat cable that is electrically powered via an electric power source. The self-regulating heat cable is made with an electrically conductive core that adjusts its conductivity based on changes in the ambient temperature. Two buss wires carry electricity to the conductive core. The cable also includes a metallic over shield along its entire length that acts as a ground. Connecting the heat cable to a supply of electricity allows it to automatically adjust the amount of current and resistance heating that occurs based on the ambient temperature to maintain a temperature sufficiently high to keep insects and pests from contacting and passing over it.

10. The system of claim 1, wherein the strip of material is made from an insulated resistance wire that is heated when an electric current passes through it. The temperature of the outer shell of the resistance wire is maintained by a temperature-control system that consists of a thermocouple in direct contact with the outer shell of the insulated resistance wire wherein the thermocouple sends an electric voltage to a central processor that converts the voltage to a temperature and then compares the temperature to a temperature pre-set into the central processor by an operator; if the thermocouple voltage is consistent with a temperature below the set-point temperature of the outer shell of the insulated resistance wire then the central processor sends an electric signal to an electric relay that causes it to close and send an electric current from a source of electricity through the resistance wire causing it to uniformly heat along its entire length; alternatively if the temperature of the outer shell of the insulated resistance wire is above the pre-set temperature set point the central processor stops sending an electric current to the electric relay allowing it to remain open and not send current through the resistance wire;

11. A method of protecting a structure with a foundation sitting on soil from invasion by insects or other pests comprising
encircling the structure to be protected with a continuous strip of material that completely encircles the structure and attaches at or near the foundation above the soil, wherein the strip of material is capable of being continuously heated to a temperature sufficient to prevent insects or other pests from contacting the strip and passing over it and into the structure;
